(19) United States
(12) Patent Application Publication
(10) Pub. No.: US 2017/0122492 A1
(43) Pub. Date: May 4, 2017

(54) Modular Decoration Hanging System

(71) Applicant: Dilan S. SILVA, Happy Valley, OR (US)

(72) Inventor: Dilan S. SILVA, Happy Valley, OR (US)

(73) Assignee: AROUND THE WORLD TECHNOLOGIES, LLC, Happy Valley, OR (US)

(21) Appl. No.: 14/932,788

(22) Filed: Nov. 4, 2015

(51) Int. Cl. F16M 13/02; B66F 19/00

(52) U.S. Cl. CPC F16M 13/022; B66F 19/00

(57) ABSTRACT

Adjustable, modular systems for suspending objects from multiple points distributed along a span include a track and a plurality of hangers that can be coupled to the track, loaded with an object, and driven along the track, the coupling, loading and driving all accomplished from a limited portion of the full span.

### CONTINUITY AND CLAIM OF PRIORITY

This is an original U.S. patent application.

### FIELD

The invention relates to devices for supporting an article by hanging it from an overhead support. More specifically, the invention relates to devices having moveable suspension elements suspended from a generally horizontal bar or track.

### BACKGROUND

In many countries, people enjoy decorating their houses for holidays and special occasions. For example, in the United States, people often hang colored lights and festive decorations along the eaves of their roofs for Halloween, Christmas and New Years. Some neighborhoods have informal competitions to see which house will be most brightly lit or gaily decorated.

The decorations are generally not left up continuously, but rather are put up a few clays before a holiday and taken clown a few clays after. To facilitate this work, small, permanent hooks are often installed along eaves, around windows and across building fascia. The hooks are used to suspend wired strings of lights and other decorations.

For lights and decorations suspended from roof eaves, one must often reach the hooks with the aid of a ladder, and must descend, move and re-ascend the ladder to suspend decorations along a horizontal span. This is time-consuming and, for multi-storey homes, it can be dangerous.

An improved means for suspending holiday lights, decorations and similar objects from a structure may be of significant value.

### SUMMARY

Embodiments of the invention provide a modular, moveable suspension system that can be “loaded” from one point, so that decorations can be placed all along roof eaves without accessing each point of suspension individually (e.g., by climbing a ladder to reach a succession of permanently-installed hooks).

### BRIEF DESCRIPTION OF DRAWINGS

FIG. 1 shows an example environment where embodiments of the invention may be installed.

FIG. 2 shows a multi-segment extruded track according to an embodiment of the invention.

FIG. 3 shows several different suspension units according to embodiments of the invention.

FIG. 4 shows a track engagement element of a suspension unit.

FIG. 5 shows another track engagement element of a suspension unit.

FIG. 6 shows a complete embodiment of the invention.

FIG. 7 shows several views of a suspension unit according to another embodiment.

FIG. 8 shows an embodiment with an alternate drive system.

FIG. 9 shows an embodiment with a different drive system.

### DETAILED DESCRIPTION

Many embodiments of the invention are conceptually similar to retractable curtains. Such curtains are suspended from a curtain rod, and the rod includes a mechanism (often a cord or tether and pulleys) by which the curtain can be drawn across the length of the rod, or retracted to one (or both) ends. However, there are a number of distinguishing features, which will be described and discussed below.

Embodiments of the invention comprise modular track segments and suspension units that can travel along the track(s), typically by sliding or rolling. Suspension units have a hook or similar feature from which a decoration or a portion of a wired string of lights may be suspended. An embodiment further comprises a drive mechanism so that the suspension units can be pushed or pulled along the track by an operator at a single location. Thus, a user can move to this location, hang an object from a suspension unit located there, and activate the drive mechanism to move the loaded suspension unit along the track. A new suspension unit can be coupled to the track, loaded with another decoration or another segment of lights, and moved along the track with the first suspension unit. By repeating these steps, decorations or lights can be distributed along the full length of the track. By reversing the steps, the decorations can be pulled back and removed from the track (again, without the user having to move along the track to reach the distributed suspension points).

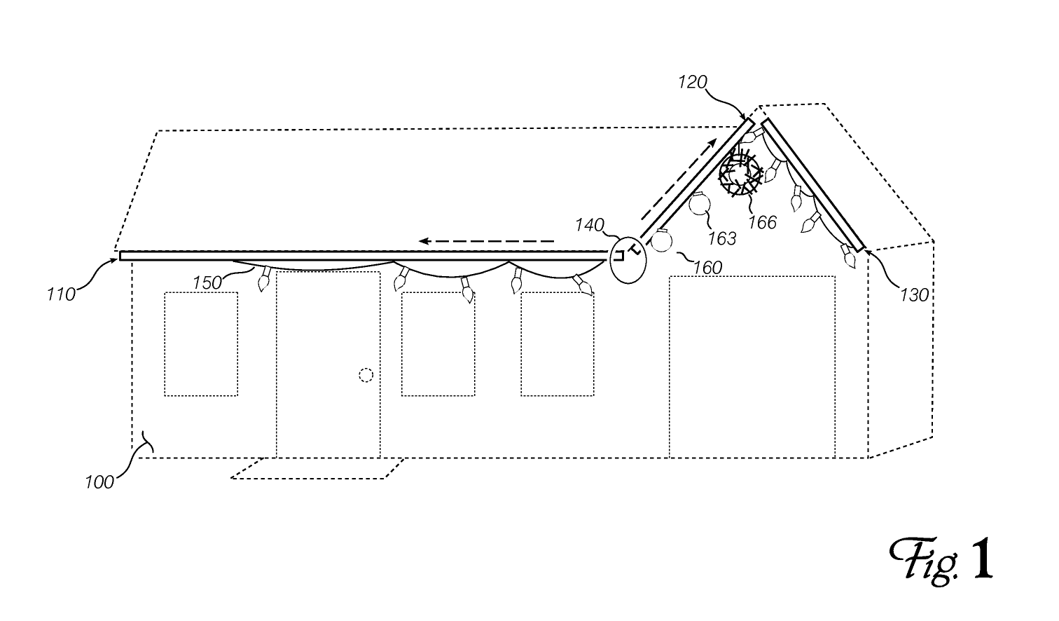

FIG. 1 shows a representative residence 100 (dashed lines), with embodiments of the invention 110, 120, 130 installed along horizontal and sloped roof eaves. To temporarily install decorations or similar objects on the building, one can access the embodiments at a common location (e.g. at 140), load the decorations (e.g., string of lights 150 or separate objects 160, 163, 165) onto suspension units and activate the drive mechanisms to cause the decorations to be carried out along the embodiment tracks. Note that in embodiments of the invention, the suspension units can be driven out (or recalled) regardless of whether they are loaded. This is in stark contrast to a retractable curtain, where the tether mechanism generally pulls the first curtain hook, but the remaining hooks are simply dragged along by virtue of their attachment to the curtain (which is being pulled by the first hook). Thus, an embodiment of the invention can suspend and move objects whether or not they are connected to each other in any way. This allows, for example, a string of lights to be installed with predetermined arcs or sag in each segment (between suspension hooks): the distance between suspension hooks remains roughly constant as the hooks are urged out along the track, so each segment of lights hangs with the slack it was given when it was placed on the hooks. Another way of expressing this distinguishing characteristic is that the suspension-unit drive force is not transmitted via the decorations being hung.

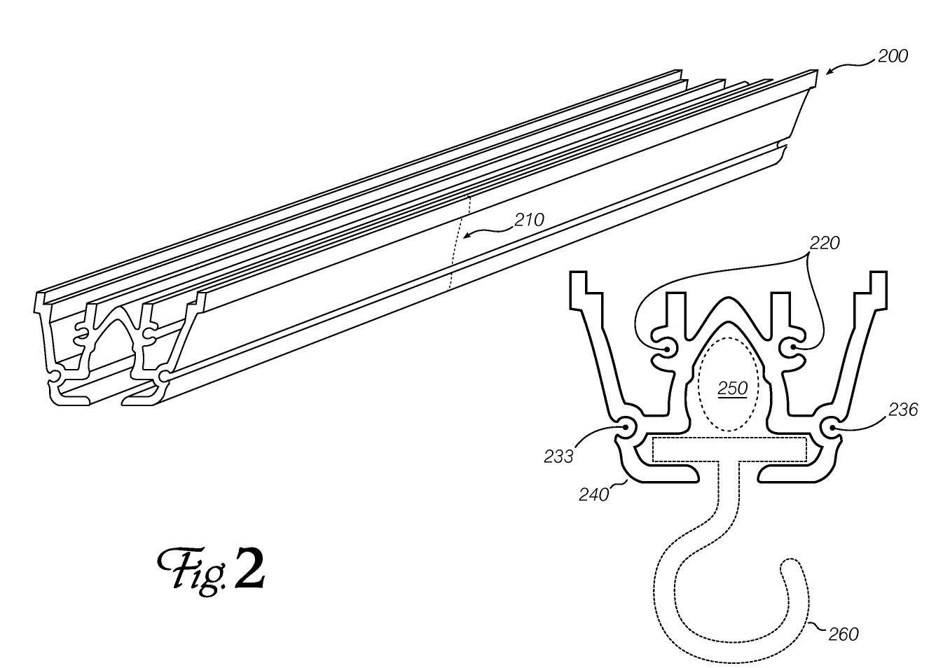

FIG. 2 shows some details of a “track” portion of an embodiment 200. This embodiment comprises a straight extrusion, which may be aluminum, plastic or another suitable material. The track may be made of several interconnected segments of similar profile (e.g., dashed line 210 indicates a segment-to-segment joint), joined end to end by complementary end features, by internal or external connection adapters, or by short aligning pins set in internal channels 220, 233, 236 shown in the enlarged cross section of the extrusion 240. The extrusion may contain a partially enclosed lengthwise channel 250 to contain the drive mechanism (discussed below). A suspension unit (represented in dashed lines at 260) is removably coupled to the track by a track engagement feature. The suspension unit includes a hook or other feature extending therefrom. The suspension unit travels (e.g., slides or rolls) along the track. Other embodiments may use a track formed from sheet rather than extruded from a bulk material. The track may be painted, powder-coated, anodized, or may have another surface coating to protect it from the elements and to promote smooth travel of the suspension units along the track. End caps may be affixed at one or both ends to prevent suspension units from traveling past the ends of the track and to discourage the ingress of water or debris.

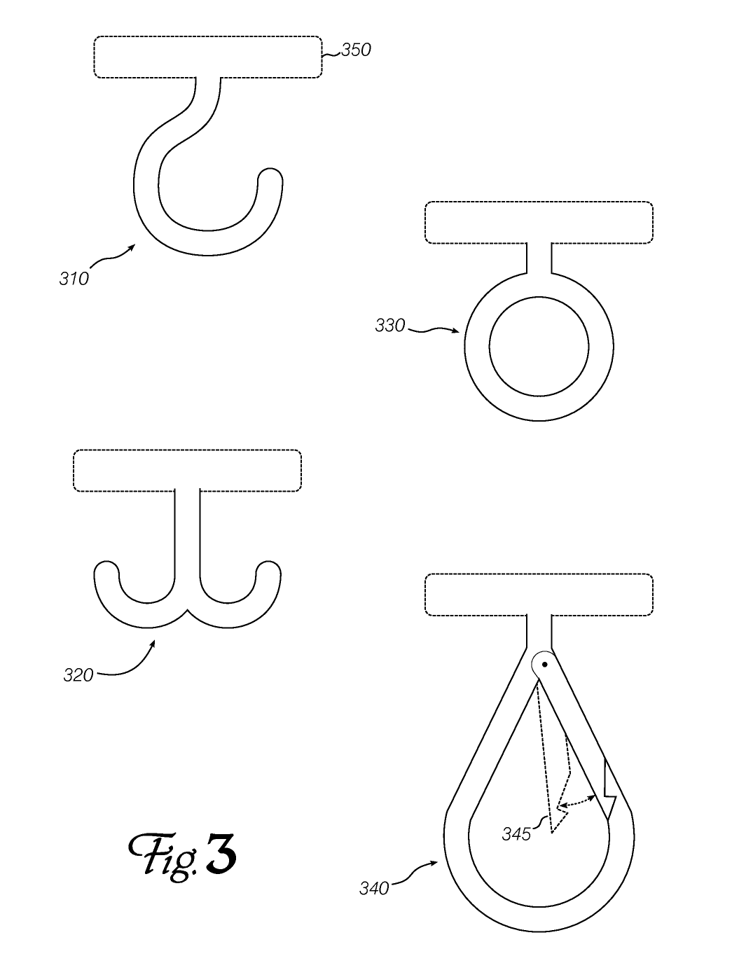

FIG. 3 shows several alternative suspension units, each adapted to couple to the track of an embodiment and to travel along the track. This figure focuses on the portion of the embodiment that interfaces with the decorations or other objects to be suspended: a suspension unit may have a simple open hook 310, a double-sided hook 320, a closed loop 330, or a loop 340 with a spring-loaded gate 345. Other configurations are also contemplated: different shapes and materials may be preferable for suspending particular objects. In addition, an embodiment may use several different suspension units on the same track—the portion of a suspension unit that couples to a track may have a common shape, construction and configuration (this portion is shown in FIG. 3 as a simple horizontal rectangle depicted in dashed lines 350). The suspension-unit-to-track coupling will be described next.

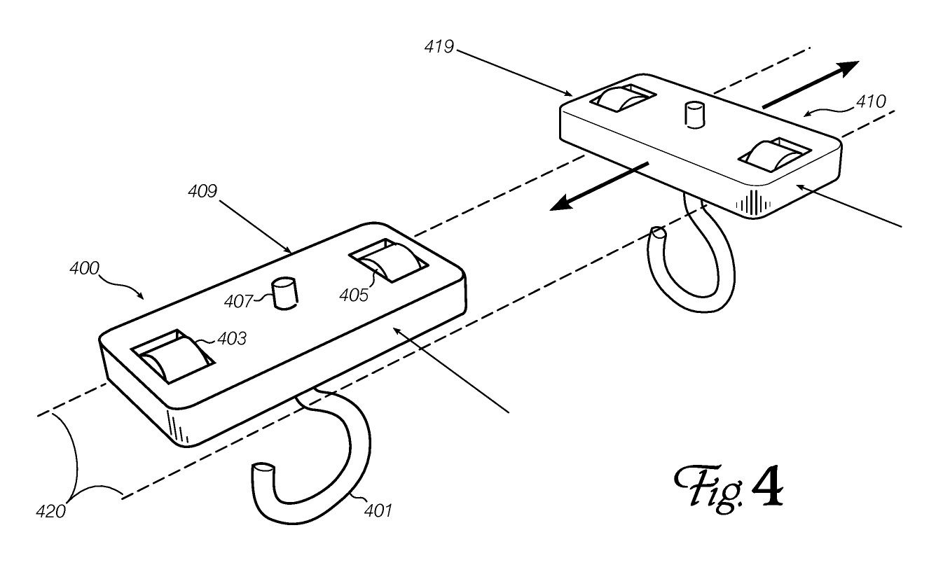

In an embodiment, individual suspension units couple reversibly to the track and can be urged to and fro along the track by the drive mechanism. Once coupled, each suspension unit typically slides or rolls along the track. For example, FIG. 4 shows two example suspension units for the extruded track depicted in FIG. 2. The first unit 400 is shown with its track engagement element or coupler oriented along the slot in the track. (The track slot edges are indicated in long-dashed lines at 420.) The coupler is narrow enough in one dimension (409) to be inserted into or removed from the slot. When rotated 90 degrees, as shown at 420, the across-slot dimension 419 of the engagement element prevents the suspension unit from being removed from the track.

Each suspension unit has a hook or similar feature 401, two wheels or bearings 403, 405, and (in this embodiment) a stub or pawl 407 that engages with the drive mechanism as discussed below.

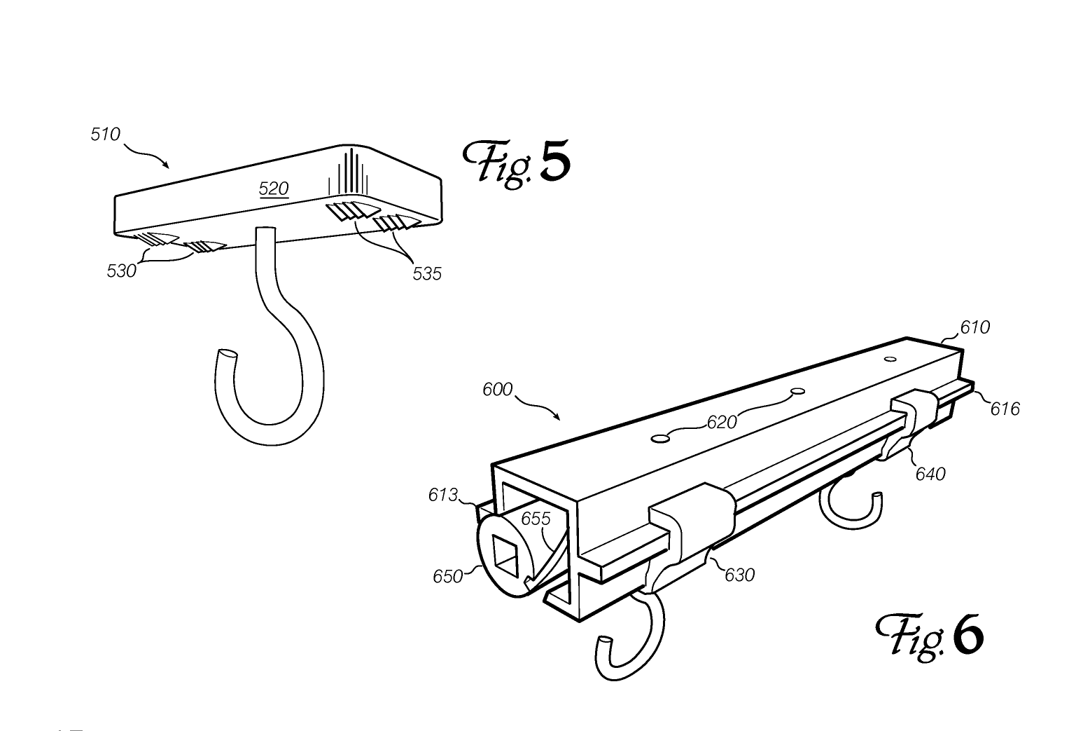

FIG. 5 shows another suspension-unit embodiment 510. Here, the track engagement element 520 is configured to slide in the track slot (rather than rolling on wheels or bearings, as in FIG. 4). The lower (sliding) surface of the coupler (i.e., the interface surface of the track engagement element) may have ridges or bumps 530, 535 to reduce the sliding surface area and friction. Preferably, these ridges or bumps are oriented in the direction of travel.

FIG. 6 shows another example embodiment 600. Here, the track 610 has fins 613, 616 extending horizontally from its sides. The track may be mounted to a surface by mounting holes 620. Suspension units 630 and 640 clip to the exterior of the track and hang from the fins, rather than traveling along an interior channel of the track. In this figure, an end of a helically-threaded drive screw 650 is visible. Stubs or pawls on the suspension units (not visible in this figure, but similar to that shown in FIG. 4 at 407) engage the spiral channel 655 so that the suspension units can be urged along the track by rotating the drive screw. This embodiment, like others, can be coupled to others like it to extend the length of the channel and increase the range of travel of the suspension units. The drive screws in successive channels may be coupled to turn in unison by a square-profile key inserted into abutting drive screw ends.

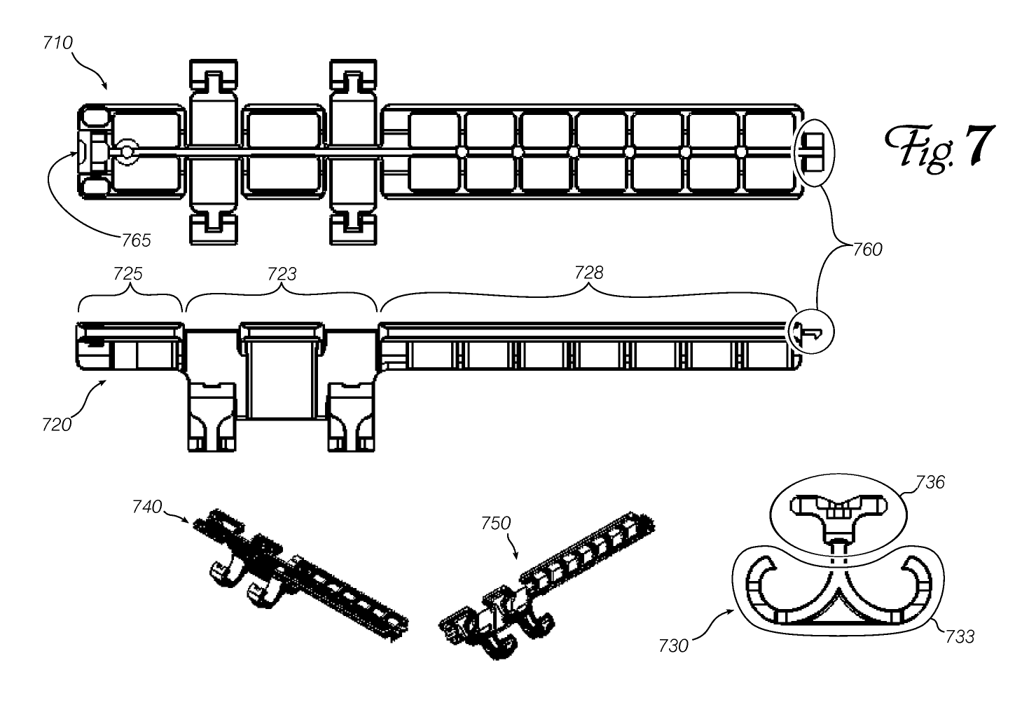

FIG. 7 shows another drive mechanism that may be used in an embodiment. In this example, the suspension unit (top view 710, side view 720, end view 730) comprises a plurality of double-ended hooks (733) coupled to a track engagement element (736). Two smaller perspective views of this suspension unit are shown at 740 and 750. Each suspension unit comprises a hook or latch 760, which couples reversibly with a corresponding receptacle of another suspension unit (at 765). Thus, one such unit may be inserted into the track of an embodiment, the hooks loaded with decorations, and the suspension unit pushed along the track so that another suspension unit may be inserted. Successive suspension units are secured to each other via the latch 760 of one and the corresponding receptacle 765 of the next.

The latch/receptacle features support tensile stress, so that a series of interconnected (latched) suspension units may be pulled from the end of the track, while the “backbones” of the suspension units—hook portion 723 and spacer portions 725 and 728—support compressive stress so that the suspension units may be pushed along the track from one end. In other words, the drive mechanism here comprises interconnected suspension units which may be pushed or pulled along the track directly by pushing or pulling the end-most suspension unit. In an embodiment like this, inter-hook spacing may be controlled by providing suspension units having spacer portions of different lengths. Each suspension unit may have zero or more hooks or similar features. (A suspension unit with zero hooks would connect two neighboring suspension units for pulling and pushing, thus serving only the “drive mechanism” function, with no “decoration suspension” function.)

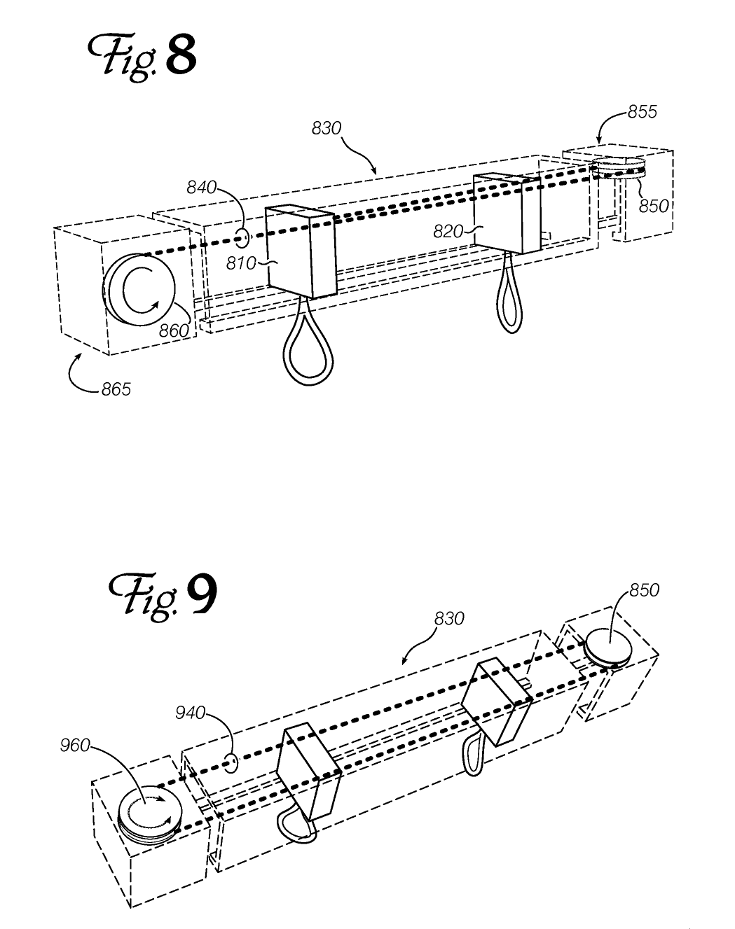

It is appreciated that embodiments of the invention are often installed outdoors, so the tracks may become dirty or acquire an oxidized surface coating, causing friction between the track and the suspension units. Since it is sometimes difficult to overcome such friction by compression (pushing), an embodiment may use a tether and pulley system to pull the suspension units out along the track. When recalling the suspension units, they may be pulled directly from the other end. This is shown in FIG. 8: suspension units 810 and 820 travel to and fro along track 830. (The track may comprise a plurality of similar segments joined end to end.) A tether (heavy dashed line 840) is secured to each suspension unit and passes out along track 830, around a turnaround pulley 850 and back to a take-up reel 860. The operator can load each suspension unit and operate take-up reel 860 to urge the suspension units out along the track; such activity can take place solely at the left (local) end of the figure. In this embodiment, the track may be have an end cap 855 housing the turnaround pulley 850 at the distal end, and another end cap 865 housing the take-up reel at the local end.

Alternatively, a continuous flexible loop tether with pulleys on either end may be provided (FIG. 9). Suspension units may clip or connect to knots on the tether loop (heavy dashed line 940), and the loop may be pulled in either direction by rotating local pulley 960 to urge the suspension units out along the track, or to recall them to the loading point.

Representative embodiments of the present invention have been described largely by reference to specific combinations of structural alternatives. However, those of skill in the art will recognize that a modular decoration hanging system within the scope of this invention can also be constructed by combining the alternate structures differently, or even by replacing certain structures by known alternatives having equivalent functionality. Such alternate combinations and variants are understood to be comprehended according to the following claims.

I claim:

1. A modular decoration hanger comprising:
a channel having a length and a substantially uniform profile along the length;
a plurality of suspension units, each having at least one hook and each adapted to be coupled to the channel and to travel along the length of the channel; and
means for urging the plurality of suspension units to travel along the length of the channel, wherein
each suspension unit of the plurality of suspension units maintains a roughly predetermined distance from an adjacent suspension unit as it is urged along the length of the channel when the at least one hooks are not loaded with any objects.

2. The modular decoration hanger of claim 1 wherein the means for urging is a helical screw that engages the suspension units so that counterclockwise rotation of the helical screw causes the suspension units to travel along the length of the channel in a first direction, and clockwise rotation of the helical screw causes the suspension units to travel along the length of the channel in a second direction opposite the first direction.

3. The modular decoration hanger of claim 1 wherein the means for urging is a spacer connecting adjacent suspension units so that motion imparted to a first suspension unit causes an adjacent second suspension unit to move similarly.

4. The modular decoration hanger of claim 1 wherein the means for urging is a tether and pulley system.

5. The modular decoration hanger of claim 1 wherein the channel comprises a plurality of channel segments coupled end to end.

6. The modular decoration hanger of claim 1, further comprising:
an end stop at one end of the channel, said end stop operative to prevent a suspension unit from traveling along the channel and past the end stop.

7. A modular decoration hanger comprising:
a straight track having a predetermined length;
a plurality of travelling hangers suited to couple to the straight track and to move along the straight track while coupled thereto; and
a drive system to cause the plurality of travelling hangers to move along the straight track while coupled thereto.

8. The modular decoration hanger of claim 7 wherein the travelling hangers are to slide along the straight track.

9. The modular decoration hanger of claim 8 wherein each travelling hanger has at least one ridge on an interface surface between the travelling hanger and the straight track, said ridge oriented in a direction of travel of the travelling hanger.

10. The modular decoration hanger of claim 7 wherein the travelling hangers are to roll along the straight track.

11. The modular decoration hanger of claim 7 wherein the drive system is one of:
a helically-threaded drive screw engaging each travelling hanger,
a backbone of each travelling hanger capable of transmitting compressive and tensile stresses to an adjacent travelling hanger connected thereto,
a tether, turnaround pulley and take-up reel system, said tether connected to each travelling hanger, or
a continuous loop tether system with two pulleys, said continuous loop tether connected to each travelling hanger.

12. A modular decoration hanging system comprising:
a plurality of similar extruded channel segments, each having a left end and a right end, where the left end of a first extruded channel segment can couple to the right end of a second extruded channel segment to form a longer extruded channel having a uniform profile; and
a plurality of suspension modules having similar track engagement elements, wherein
at least two suspension modules further comprise a decoration engagement element,
each suspension module couples reversibly to the longer extruded channel via the similar track engagement element of the respective suspension module so that each suspension module can travel along the longer extruded channel, and
a distance between two adjacent suspension modules is held roughly constant as the adjacent suspension modules travel along the longer extruded channel.

13. The modular decoration hanging system of claim 12 wherein a suspension module travels along the longer extruded channel by sliding.

14. The modular decoration hanging system of claim 12 wherein a suspension unit travels along the longer extruded channel by rolling.

15. The modular decoration hanging system of claim 12 wherein the decoration engagement element of one of the at least two suspension modules is a single-sided hook.

16. The modular decoration hanging system of claim 12 wherein the decoration engagement element of one of the at least two suspension modules is a double-sided hook.

17. The modular decoration hanging system of claim 12 wherein the decoration engagement element of one of the at least two suspension modules is a closed loop.

18. The modular decoration hanging system of claim 12 wherein the decoration engagement element of one of the at least two suspension modules is a loop with a spring-loaded gate.

19. The modular decoration hanging system of claim 12 wherein the decoration engagement element of a first of the at least two suspension modules is different from the decoration engagement element of another of a second of the at least two suspension modules.

20. The modular decoration hanging system of claim 12 wherein at least one suspension module lacks a decoration engagement element.
